(19) United States
(12) Patent Application Publication
(10) Pub. No.: US 2008/0202083 A1
(43) Pub. Date: Aug. 28, 2008

(54) Grease filter

(76) Inventors: Thomas Graham, Ocean, NJ (US); Martin P. Burns, Forked River, NJ (US)

Correspondence Address: Francis C. Hand, Esq.;c/o Carella, Byrne, Bain, Gilfillan,, Cecchi, Stewart & Olstein, 5 Becker Farm Road, Roseland, NJ, 07068, US

(21) Appl. No.: 11/710,072

(22) Filed: Feb. 23, 2007

(51) Int. Cl. B01D 45/00

(52) U.S. Cl. 55/444; 55/443

(57) ABSTRACT

The grease filter is provided with an internal baffle to filter grease out of the air/vapor flow passing through the passages in the front face. In one embodiment, the baffle is of corrugated shape and is secured in place between two plates of the grease filter. In a second embodiment, individual baffles of tubular shape are fitted into the passages of the front face. In each embodiment, the baffles are provided with hexagonal holes that constitute an open area of from 63% to 79% of the baffle.

This invention relates to a grease filter. More particularly, this invention relates to a grease filter for commercial kitchens.

As is known, commercial kitchens such as in fast food establishments employ a series of stoves for cooking food. Typically, the stoves have overhead fans for drawing off heated air, vapors and grease. In order to trap the grease being drawn off, filters have been placed between the fans and the stove in order to catch the grease and to redirect the grease to a suitable outlet.

U.S. Pat. No. 6,840,975 describes a grease filter that has a pair of plates secured together by a peripheral frame into a box-like shape. In addition, each plate has a plurality of passages defined by inwardly directed pairs of louvers for a flow of air and vapor. The louvers on opposite sides of the grease filter are also staggered relative to each other to create a flame barrier. That is, the openings of the louvers are staggered relative to each other so that a flame can not pass directly through the openings of the louvers from one side of the filter to the other side.

In other cases, grease filters for commercial kitchens have been constructed of two pieces that fit one within the other to define a flat box-like structure. In addition, each filter piece has been provided with passageways, usually defined by louvers that are bent into the box-like structure, in a front wall and a back wall.

Typically, the grease filters are mounted so that an upward flow of air and vapor passes into the passages of the front wall of the filters before being deflected within the grease filters to pass out through the passages in the back wall. During travel through the grease filter, the grease within the airflow is deposited onto the louvers as well as onto any internal structure within the grease filter. The grease eventually trickles under gravity to a lower most point within the filter and passes through suitable openings in the filter to a take-off means.

It is an object of the invention to provide a grease filter that is highly efficient in removing grease from an air/vapor flow passing through the filter.

It is an object of this invention to provide a high efficiency grease filter of economic construction.

It is another object of the invention to provide a grease filter which is of robust construction.

It is another object of the invention to provide a grease filter that can be fabricated in a relatively simple economical manner.

Briefly, the invention provides a grease filter that is provided with an internally disposed baffle that is situated to increase the amount of grease capture with a minimal increase in static pressure through the filter.

The grease filter is constructed with a front face having a plurality of spaced apart parallel passages therein for a flow of air and vapor therethrough and the baffle is positioned in alignment with at least one of the passages to intercept a flow of air and vapor therefrom. The baffle has a plurality of holes for the passage of an air/vapor flow and a plurality of ribs for filtering grease particles from the air/vapor flow passing through the baffle. In order to minimize any increase in back pressure caused by the baffle being placed in the air stream, the holes define an open area of from 63% to 79% in the baffle. In particular, use is made of staggered rows of hexagon shaped holes since this configuration provides the maximum open area.

In addition, the baffle when made by punching with a punch and die typically has a rolled over edge about each opening on one side of the baffle and burrs about each opening on the opposite side. The baffle is, thus, placed with the burrs on the downstream side in order to impart turbulence in the air/vapor flow passing thereby. This will serve to dislodge even more grease from the air/vapor flow.

In one embodiment, the grease filter is constructed of a pair of parallel plates that form the front face and the back face of the filter and each plate is provided with passages for a flow of air and vapor therethrough. In this embodiment, the baffle is formed of sheet metal and is positioned between the plates transversely of the passages. In addition, the baffle is secured to one of the plates by fasteners, for example by means of rivets.

Each plate is provided with pairs of spaced apart inwardly directed louvers to define the parallel passages for the flow of air and vapor therethrough. The baffle is, in turn, of a zig-zag shape to fit over the pairs of louvers in spaced relation. In addition, the holes of the baffle are placed in alignment with the passages and are of a size to filter grease particles from the air and vapor passing therethrough. That is to say, as the grease-laden air strikes the ribs between the holes in the baffle, grease particles are dislodged from the air stream and run down the ribs of the baffle into the interior of the filter.

In another embodiment, individual baffles are positioned in alignment with the passages in the upstream plate of the grease filter, i.e. the back plate. Each of these baffles is made of flat sheet metal with a honeycomb pattern of holes that is formed into a tubular shape with a rectangular cross-section. The shape and size of each baffle is such as to allow the baffle to be individually positioned between the louvers of the back plate and held in place on this plate, for example, by spring deflection of the louvers or by means of one or more tack welds.

These and other objects and advantages of the invention will become more apparent from the following detailed description taken in conjunction with the accompanying drawings wherein.

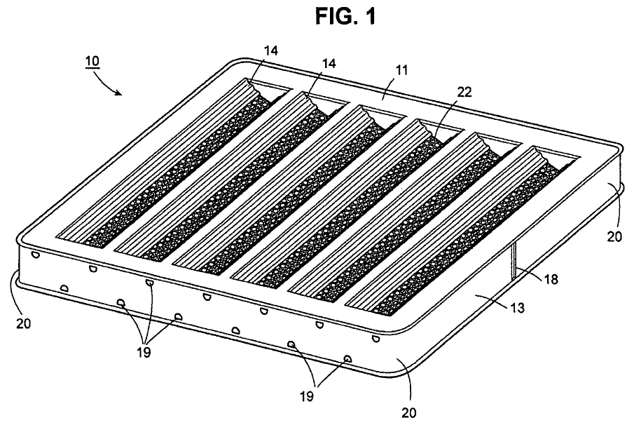

FIG. 1 illustrates a perspective view from the front of a grease filter construction in accordance with the invention;

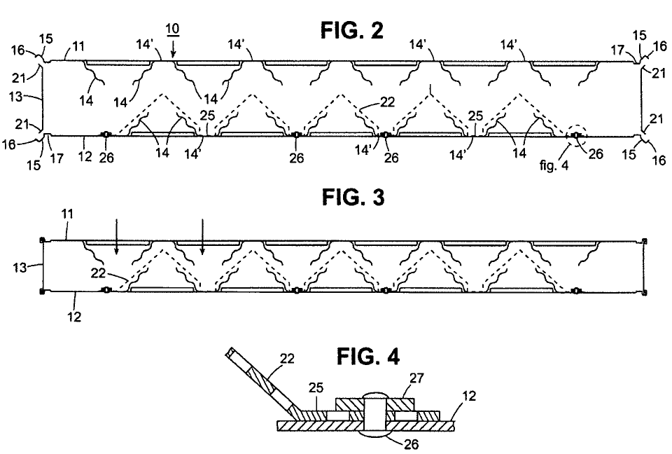

FIG. 2 illustrates a part-exploded view of the components of the grease filter of FIG. 1;

FIG. 3 illustrates a cross-sectional view of the grease filter of FIG. 1;

FIG. 4 illustrates a detailed cross sectional view of a rivet connection for securing the baffle of the filter in place;

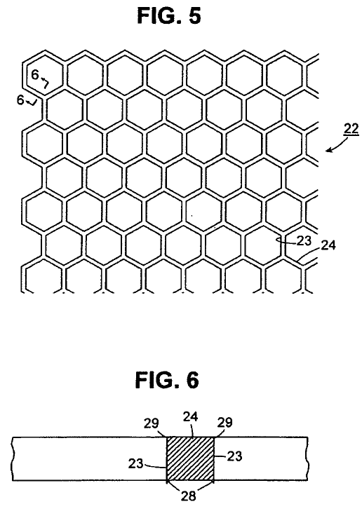

FIG. 5 illustrates a partial view of the baffle of the grease filter of FIG. 1;

FIG. 6 illustrates a cross-sectional view of a part of the baffle;

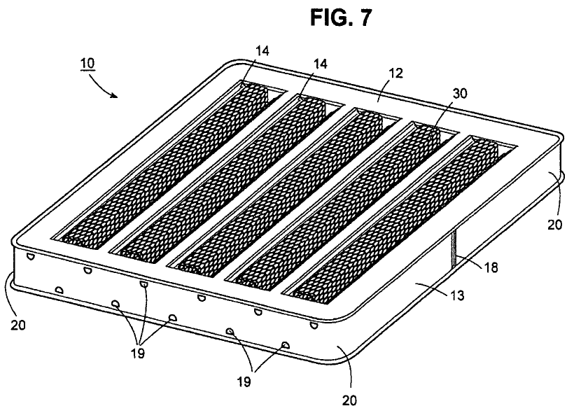

FIG. 7 illustrates a perspective view from the back of a modified grease filter construction in accordance with the invention; and

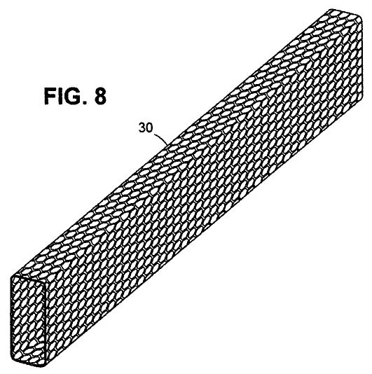

FIG. 8 illustrates a perspective view of a tubular baffle employed in the embodiment of FIG. 7.

Referring to FIG. 1, the grease filter 10 is constructed with a front plate 11, a back plate 12 and a rectangular frame 13.

The front plate 11 is made from a flat blank of a suitable material, such as stainless steel, that is stamped or otherwise worked into the illustrated shape, i.e. a rectangular shape with radiused corners. The plate 11 is also provided with a plurality of pairs of inwardly directed louvers 14 extending from flat ribs 14′ so that each pair of louvers 14 defines a passage. FIG. 1 illustrates a grease filter 10 with six spaced apart parallel passages in the face of the filter 10, i.e. in the front plate 11.

As illustrated in FIG. 2, the plate 11 has an outwardly directed flange 15 at the periphery that is angularly disposed, e.g. at an angle of 45° to the plane of the plate 11. Each flange 15 also has a lip 16 extending, e.g. at a 90° angle from the edge of the flange 15 towards the plane of the plate 11. Also, a recess 17 extends peripherally of the plate 11 adjacent the flange 15

The back plate 12 is constructed in a similar manner as the front plate except that the pairs of louvers 14 are staggered relative to the pairs of louvers 14 in the front plate 11. In this way, the passages in the back plate 12 are in staggered relation to the passages in the front plate 11. As indicated in FIG. 3, the back plate 12 has five spaced apart parallel passages.

The rectangular frame 13 is disposed between and peripherally of the front plate 11 and back plate 12. Typically, the rectangular frame 13 is made from one or more strips of material, such as stainless steel. In the illustrated embodiment, a single strip is used with the ends 18 thereof disposed in overlapping seamed relation as indicated in FIG. 1. In addition, at least one section of the rectangular frame 13 that is to define the bottom of the grease filter 10 is provided with a plurality of staggered openings 19 to allow grease and debris within the grease filter 10 to fall under gravity out of the bottom of the filter 1 when in use.

As shown in FIG. 1, the rectangular frame 13 is formed with radiused corners 20 adapted to the size and shape of the plates 11,12 and, as shown in FIG. 2, the frame 13 is flat with a pair of flanges 21 extending angularly outwardly thereof, for example, at an angle of 45°.

As shown in FIG. 2, a baffle 22 is secured to the back plate 12 transversely of the passages therein.

As shown FIG. 5, the baffle 22 has a plurality of holes 23, for example of hexagonal shape, that are separated by ribs 24. The holes 23 provide for the passage of an air/vapor flow and the ribs 24 serve to filter grease particles from the air/vapor flow passing through the holes 23. These holes 23 constitute an open area of from 63% to 79% of the baffle. By way of example, as illustrated, the holes 23 are disposed in a honeycomb shaped pattern wherein each hole 23 is hexagonally shaped and is greater in width than a rib 24. Each rib 24 is preferably of a width equal to or slightly greater than the thickness of the baffle 22 for ease of manufacture. The baffle 22 typically has a thickness of 1/32 inch. Should the ribs 24 be made narrower than the thickness of the baffle 22, this can cause difficulty in the manufacture of the baffle 22 due to distortion of the narrower ribs.

As illustrated, the width A of each hole 23 is ¼ inch and the thickness B of each rib 24 is 1/32 inch such that the pitch C of the holes 23, i.e. the centerline to centerline distance of the holes 23, in a given horizontal row, is 9/64 inch. The pitch D of the holes 23, i.e. the centerline to centerline distance of the holes 23, in a vertical row is ¼ inch.

Referring to FIG. 2, the baffle 22 is of zig-zag shape and is inter-fitted about the pairs of louvers 14 of the back plate 12. As illustrated, the baffle 22 has a plurality of flat sections 25 that are disposed in parallel between the louvers 14 of the two plates 11,12.

As illustrated, the flat sections 25 of the baffle 22 define of an angle approximately equal to that as defined by the louvers 14 with an apex that is in line with the passage that is defined by a respective pair of louvers 14 in the back plate 12.

Referring to FIG. 2, in order to fabricate the grease filter 10, the baffle 22 is secured to the back plate 12 by means of a plurality of fasteners, such as rivets 26. As shown in FIG. 4, each rivet 26 is a pop rivet and is employed with a washer 27 in order to secure the baffle 22 to the back plate 12. For a standard size grease filter 8 rivets are used to secure the baffle 22 in place on the back plate 12.

Thereafter, the plates 11, 12 and frame 13 are placed in a suitable holder (not shown) so that the flanges 21 of the frame 13 abut the outstanding flange 15 of the respective plates 11, 12. Thereafter, the fixture (not shown) is actuated so that the lip of each of the plates 11, 12 is folded over the flange 21 of the frame 13. As this process continues, the peripheral edges of the frame and the plates are further folded into a rolled canned-style seam 22 in a manner as described in U.S. Pat. No. 6,840,975.

As shown in FIG. 3, after assembly, the baffle 22 is disposed in interdigitated relation between the louvers 14 in the front and back plates 11,12. That is to say, the plane of the louvers 14 of the front plate overlap with the plane of the louvers 14 of the back plate 12 with the flat sections 25 of the baffle 22 therebetween.

Referring to FIG. 6, during fabrication of the stock material using a punch and die, the method of punching the holes 23 causes a burr 28 in the ribs 24 on the side toward the die and a rolled-over edge 29 on the side toward the punch. This is used to advantage by forming the stock material into the zig-zag shaped baffle 10 with the burr side facing downstream relative to the flow of air/vapor through the holes 23. These burrs 28 serve to impart turbulence in the air/vapor flow passing through the holes 23 in order to dislodge even more grease from the air stream. The opposite side of each rib 24 has a rolled over edge 29 about the respective hole 23.

When in use, an air/vapor stream passing through the grease filter 10 in the direction indicated by the arrows in FIG. 3 will deposit grease onto the louvers 14 as well as on to the solid surfaces of the ribs 24 of the baffle 22. Thus, the presence of the baffle 22 increases the grease-removing efficiency of the filter 10. The grease which accumulates on the baffle 22 as well as the grease on the louvers 14 falls under gravity to the bottom of the filter 10 to pass outwardly through the openings 19 in the bottom sidewall of the frame 13.

Referring to FIG. 7, wherein like reference characters indicate like parts as above, the grease filter 10′ may be provided with a plurality of baffles 30 that are individually positioned in a respective passage between a pair of louvers 14 of the back plate 12 and held in place against a respective rib 14′ in the front plate 11.

Referring to FIG. 8, each baffle 30 is made of sheet metal with a plurality of holes 23, as above, in a honeycomb pattern for the passage of air and vapor therethrough and a plurality of ribs 24 for filtering grease particles from the air/vapor flow passing through the baffle 30.

As illustrated, each baffle 30 is of tubular shape with a rectangular cross-section. The shape and size of each baffle 30 is such as to allow the baffle 30 to be individually pressed into a passage between a pair of louvers 14 of the back plate 12 so as to be spring mounted between the louvers 14 of the back plate 12 and held in place by the spring deflection of the louvers 14 of the back plate 12 or by means of one or more tack welds (not shown).

When in place, each baffle 30 is positioned so that grease-laden air that passes into the filter 10′ between the louvers 14 of the front plate 11 must pass through the baffles 30 before exiting through the back plate 12. As a result, grease can be captured on the ribs 24 of the baffles 30.

One advantage of the use of the individual baffles 30 is that the baffles 30 can be assembled in place after the main parts of the grease filter 10′ have been fabricated. Likewise, should one or more of the baffles 30 require replacement, that baffle 30 can be removed and replaced with a fresh baffle 30 without need to disassemble the grease filter 10′.

The invention thus provides a grease filter of an increased efficiency in removing grease from an air stream. Further, the invention provides a grease filter of high efficiency that can be readily fabricated.

The grease filter may be made of any suitable construction to receive the baffles described above. For example, the grease filter may be made such that the front face is formed by individual parallel ribs that are secured in place in a frame. The grease filter may also be formed by front and back plates that each have peripheral flanges for interfitting of the two plates in a box-like manner and that have parallel ribs or louvers to define passages into and through the filter.

What is claimed is:

1. A grease filter comprising
a front face having a plurality of spaced apart parallel passages therein for a flow of air and vapor therethrough; and
a baffle positioned in alignment with at least one of said passages to intercept a flow of air and vapor therefrom, said baffle having a plurality of holes therein for the passage of an air/vapor flow and a plurality of ribs for filtering grease particles from the air/vapor flow passing through said baffle.

2. A grease filter as set forth in claim 1 wherein said baffle is disposed across said passages.

3. A grease filter as set forth in claim 2 wherein each said hole is hexagonally shaped and is greater in width than a respective rib.

4. A grease filter as set forth in claim 2 wherein said baffle has a plurality of holes therein defining an open area of from 63% to 79% in said baffle.

5. A grease filter as set forth in claim 1 wherein said baffle is of tubular shape with a rectangular cross-section.

6. A grease filter as set forth in claim 1 further comprising a back face having a plurality of spaced apart parallel passages disposed in staggered relation to said passages in said front face for a flow of air and vapor therethrough.

7. A grease filter comprising
a first plate having a plurality of pairs of spaced apart inwardly directed louvers defining a plurality of parallel passages for a flow of air and vapor therethrough;
a second plate parallel to said first plate and having a plurality of pairs of spaced apart inwardly directed louvers defining a plurality of parallel passages for a flow of air and vapor therethrough, said pairs of louvers of said second plate being offset from said pairs of louvers of said first plate and disposed in interdigitated relation to said pairs of louvers of said first plate; and
a baffle of zig-zag shape secured to one of said plates transversely of said passages therein, said baffle having a plurality of holes therein for passage of air and vapor therethrough and a plurality of ribs for filtering grease particles from the air/vapor flow passing through said baffle.

8. A grease filter as set forth in claim 7 wherein said baffle is interfitted about said pairs of louvers of said first plate.

9. A grease filter as set forth in claim 7 further comprising a plurality of fasteners securing said baffle to said first plate, each said fastener being disposed at a point between a respective pair of louvers in said first plate.

10. A grease filter as set forth in claim 7 wherein each said plate is made of sheet metal and said baffle is made of sheet metal.

11. A grease filter as set forth in claim 7 wherein said holes in said baffle are disposed in a honeycomb shaped pattern wherein each hole is hexagonally shaped.

12. A grease filter as set forth in claim 11 wherein said baffle has a predetermined thickness and each said rib is of a width equal to said predetermined thickness.

13. A grease filter as set forth in claim 7 wherein said holes in said baffle define an open area of from 63% to 79% in said baffle.

14. A grease filter as set forth in claim 7 wherein each said rib has a plurality of burrs, each said burr being directed towards the other of said plates to impart turbulence in an air and vapor flow passing thereby.

15. A grease filter as set forth in claim 7 further comprising a frame secured peripherally of and between said first plate and said second plate.

16. A grease filter comprising
a first plate having a plurality of pairs of spaced apart inwardly directed louvers defining a plurality of parallel passages for a flow of air and vapor therethrough;
a second plate parallel to said first plate and having a plurality of pairs of spaced apart inwardly directed louvers defining a plurality of parallel passages for a flow of air and vapor therethrough, said pairs of louvers of said second plate being offset from said pairs of louvers of said first plate; and
a plurality of baffles between said first plate and said second plate, each said baffle being positioned in alignment with a respective passage in said second plate and having a plurality of holes therein for passage of air and vapor therethrough and a plurality of ribs for filtering grease particles from the air/vapor flow passing through said baffle.

17. A grease filter as set forth in claim 16 wherein each said baffle is of tubular shape with a rectangular cross-section.

18. A grease filter as set forth in claim 17 wherein each said baffle is disposed between a respective pair of inwardly directed louvers in said second plate.

19. A grease filter as set forth in claim 17 wherein each said baffle is spring mounted between a respective pair of inwardly directed louvers in said second plate.

20. A grease filter as set forth in claim 16 wherein said holes in each said baffle are disposed in a honeycomb shaped pattern with each hole being hexagonally shaped.

21. A grease filter as set forth in claim 20 wherein said holes in said baffle define an open area of from 63% to 79% of said baffle.
